(19) United States
(12) Patent Application Publication
(10) Pub. No.: US 2019/0066014 A1
(43) Pub. Date: Feb. 28, 2019

(54) WORK TASK ASSIGNMENT METHOD, APPARATUS AND COMPUTING SYSTEM

(71) Applicant: Alibaba Group Holding Limited, Grand Cayman (KY)

(72) Inventor: Shuimin Wang, Hangzhou (CN)

(21) Appl. No.: 16/110,910

(22) Filed: Aug. 23, 2018

(30) Foreign Application Priority Data
Aug. 24, 2017 (CN) 201710737853.7

(51) Int. Cl. G06Q 10/06

(52) U.S. Cl. CPC G06Q 10/06311

(57) ABSTRACT

Example embodiments of the present disclosure disclose a work task allocation method, apparatus and computing system, wherein, the method includes: determining information of work personnel within multiple stores, the work personnel information including information of stores to which they belong and work areas they are responsible for; grouping information of multiple work personnel responsible for a same work area within a same store according to differences between work task types, and binding each group of work personnel with respective work task types, wherein, work personnel within a same group are bound with the same work task type, and work personnel of different groups are bound with different work task types; after work tasks are generated, determining target work personnel responsible for target work area(s) within a target store and having a binding relationship with the types of the work tasks, used to allocate the work tasks to the target work personnel. Through example embodiments of the present disclosure, improved efficiency may be achieved.

### CROSS REFERENCE TO RELATED PATENT APPLICATIONS

This application claims priority to Chinese Patent Application No. 201710737853.7, filed on Aug. 24, 2017 and entitled “WORK TASK ASSIGNMENT METHOD, APPARATUS AND COMPUTING SYSTEM”, which is incorporated herein by reference in its entirety.

### TECHNICAL FIELD

The present disclosure relates to the field of work assignment allocation techniques, and, more particularly, to work assignment allocation methods, apparatuses and computing systems.

### BACKGROUND

“Hema Supermarket” and such retail platforms are a “new retail” format which re-envisions offline supermarkets. For this kind of retail platform, offline stores are deployed which may be supermarkets, restaurants, and farmers' markets, where customers may make in-store purchases, or may use a related app to make offline purchases. A particular distinction provided is rapid delivery, offering, for example, 30-minute delivery to door within a 3-mile range of a store, and the like.

Herein, within a store, related work personnel are configured to undergo different divisions of labor, including pickers, packagers, deliverers, and the like; with regard to online orders, often related work personnel within a store perform multiple linked operations such as picking, packaging, delivering and the like, ultimately delivering to a delivery address instructed by a user. As the products on sale within a store may be numerous, while the number of users constantly increases, orders will grow explosively; in situations where resources such as manpower within a store are limited, ensuring that goods are delivered to a user's door within a promised time becomes a technical problem requiring persons skilled in the art to solve.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The present disclosure provides work task allocation methods, apparatuses and computing systems, which may avoid various different types of work tasks becoming backlogged for handling by a same work personnel, resulting in the occurrence of phenomena such as waiting and decreased efficiency.

The present disclosure provides the following schemes:

A work task allocation method, including:

Determining information of work personnel within multiple stores, the work personnel information including information of stores they belong to and work areas they are responsible for;

Grouping information of multiple work personnel responsible for a same work area within a same store based on differences in work task types, and binding each group of work personnel with respective work task types, wherein, work personnel within a same group are bound with the same work task type, and work personnel of different groups are bound with different work task types;

After a work task is generated, determining target work personnel responsible for a corresponding target work area within a target store and having a binding relationship to a type of the work task, and allocating the work task to the target work personnel.

A work task claiming method, including:

Submitting information of work personnel within a store to a server, the server grouping information of multiple work personnel within a same store and responsible for a same work area based on differences in work task type, and binding work personnel of each group and work task types, wherein, work personnel within a same group are bound with the same work task type, and work personnel of different groups are bound with different work task types, the information of the work personnel including information of the store to which they belong and the work area which they are responsible for;

Receiving work tasks allocated by the server, wherein, the work tasks are allocated based on types of the tasks and the binding relationship between the work personnel and work task types.

A work task allocation method, including:

Determining information of work personnel within a store, the work personnel information including information of work areas for which they are responsible for;

Grouping information of multiple work personnel responsible for a same work area based on differences in work task types, and binding each group of work personnel with respective work task types, wherein, work personnel within a same group are bound with the same work task type, and work personnel of different groups are bound with different work task types;

After a work task is generated, determining target work personnel responsible for a corresponding target work area and having a binding relationship to a type of the work task, and allocating the work task to the target work personnel on a prioritized basis.

A work task allocation apparatus, including:

A first personnel information determining unit, operative to determine information of work personnel within multiple stores, the work personnel information including information of stores to which they belong and work areas to which they are responsible for;

A first task type binding unit, operative to group information of multiple work personnel within a same store and responsible for a same work area based on differences in work task types, and to bind each group of work personnel with a respective work task type, wherein, work personnel of a same group are bound with the same work task type, and work personnel of different group are bound with different work task types;

A first target personnel determining unit, operative to, after work tasks are generated, determine target work personnel responsible for a corresponding work area within a corresponding store and having a binding relationship with types of the work tasks, and operative to allocate the work tasks to the target work personnel.

A work task claiming apparatus, including:

An information submitting unit, operative to submit information of work personnel within a store to a server, causing the server to group information of multiple work personnel within a same store and responsible for a same work area based on differences between work task types, and perform binding between each work personnel group and respective work task type, wherein, work personnel within a same group are bound with the same work task type, and work personnel of different groups are bound with different work task types, the work personnel information including information of stores to which they belong and work areas which they are responsible for;

A task receiving unit, operative to receive work tasks allocated by the server, wherein, the work tasks are allocated based on the types of the tasks and binding relationships between the work personnel and the work task types.

A work task allocation apparatus, including:

A second personnel information determining unit, operative to determine information of work personnel within a store, the work personnel information including information of the work areas they are responsible for;

A second task type binding unit, operative to group information of multiple work personnel responsible for a same work area based on differences between work task types, and bind each group of work personnel with a respective work task type, wherein, work personnel within a same group are bound with the same work task type, and work personnel of different groups are bound with different work task types;

A second target personnel determining unit, operative to, after a work task is generated, determine target work personnel responsible for a corresponding work area and having a binding relationship with a type of the work task, and allocating the work task to the target work personnel on a prioritized basis.

A computing system, including:

One or more processors; and

Memory related to the one or more processors, the memory operative to store program instructions, the program instructions upon being read and executed by the one or more processors, execute the following operations:

Determine information of work personnel within multiple stores, the work personnel information including information of the stores to which they belong and the work areas they are responsible for;

Group information of multiple work personnel within a same store and responsible for a same work area based on differences between work task types, and bind each group of work personnel with a respective work task type, wherein, work personnel within a same group are bound with the same work task type, and work personnel of different groups are bound with different work task types;

After a work task is generated, determine target work personnel corresponding to a target work area within a target store and having a binding relationship to a type of the work task, and operative for the allocation of the target work personnel to the work task.

Based on the particular example embodiments provided by the present disclosure, the present disclosure discloses the following results:

According to example embodiments of the present disclosure, by binding a particular work task type to a work personnel, a same work area will have work personnel each exclusively responsible for executing various different types of work tasks, and work tasks may be allocated according to an above-mentioned binding relationship, prioritizing allocation where they exist. By this process, simplicity is achieved for work tasks executed by each personnel, avoiding various different types of work tasks being backlogged for handling by the same work personnel, resulting in the occurrence of waiting, decreased efficiency and such phenomena.

Of course, either product of the present disclosure need not achieve each of the above-mentioned advantages at the same time.

### BRIEF DESCRIPTION OF THE DRAWINGS

To describe the technical solutions in the example embodiments of the present disclosure more clearly, the following briefly introduces the accompanying drawings describing the example embodiments. It will be apparent that the accompanying drawings described in the following merely represent some example embodiments described in the present disclosure, and those of ordinary skill in the art may still derive other drawings from these accompanying drawings without creative efforts.

FIG. 1 is a diagram of an application setting according to an example embodiment provided by the present disclosure.

FIG. 2 is a diagram of task allocation information interaction according to an example embodiment provided by the present disclosure.

FIG. 3 is a flowchart of a first method according to an example embodiment provided by the present disclosure.

FIG. 4 is a flowchart of a second method according to an example embodiment provided by the present disclosure.

FIG. 5 is a flowchart of a third method according to an example embodiment of the present disclosure.

FIG. 6 is a diagram of a first apparatus according to an example embodiment provided by the present disclosure.

FIG. 7 is a diagram of second apparatus according to an example embodiment of the present disclosure.

FIG. 8 is diagram of a third apparatus according to an example embodiment of the present disclosure.

FIG. 9 is a diagram of a computing system according to an example embodiment of the present disclosure.

### DETAILED DESCRIPTION

In order to enable those skilled in the art to better understand the technical solutions in the present disclosure, the technical solutions in the example embodiments of the present disclosure will be described clearly and completely through the accompanying drawings in the example embodiments of the present disclosure. It will be apparent that the described example embodiments represent merely some of example embodiments of the present disclosure, rather than all the example embodiments. Based on the example embodiments of the present disclosure, all other example embodiments derived by those of ordinary skill in the art without any creative effort shall fall within the protection scope of the present disclosure.

For ease of understanding example embodiments of the present disclosure, the below will simply introduce first the above-mentioned scheme of “separate picking, converging packaging” and then the scheme of “integrated picking and packaging.”

With regard to the scheme of “separate picking, converging packaging,” in order to further improve the efficiency of picking and delivery, the following solution schemes are provided: dividing the physical space of an offline physical storefront (or “store” and the like) into different work areas, for example, dividing into a “picking area,” a “packaging area,” and the like, and grouping work personnel corresponding to different work area assignments, for example, dividing into “picking personnel,” “packaging personnel,” and the like. Herein, a picking area is used to place particular products, including fruits, vegetables and the like; a packaging area is used to perform packaging operations on products that have been picked. After receiving a particular customer order, a system may generate corresponding picking tasks, wherein, since a same order may include multiple different data objects (products, and the like), and these data objects may be distributed among different picking areas, therefore, multiple picking tasks may be generated, and after picking personnel at respective corresponding picking areas have performed picking operations, sent to the packaging area to perform a unitary packaging operation. Additionally, in situations where numerous orders are received concurrently, to improve delivery efficiency, a system, before generating picking tasks, may also first, based on information such as an instructed receiving time of an order, a receiving address and the like, perform order merge processing, merging multiple orders having proximate receiving times and receiving addresses into a same wave, and a same delivery personnel performs delivery upon orders of a same wave. Thus, the generation of picking tasks may utilize a wave as a unit; to generate picking tasks for each wave, different picking tasks may likewise be generated based on differences in picking areas where each data object included in a wave is present; after all of multiple picking tasks within a wave are completed, packaging personnel of a packaging area again perform packaging operations based on the situation of particular orders of a wave, and finally, the packaging results corresponding to each order of a same wave are given to a same delivery personnel to undergo delivery. By particular implementations, situations occur where there is only one order in a wave: for example, if the number of data objects included in some order is relatively large; or, when for some order there is no other order having proximate delivery time, delivery address and the like, a wave may be generated solely for that order. Therefore, according to example embodiments of the present disclosure, a “wave” may be designated as a unit that undergoes generation of picking tasks, wherein each wave may include one or more orders therein.

To further improve efficiency, avoiding sending completed results of picking to a packaging area by a manual fashion, a suspended chain conveyor system may be deployed within a physical storefront, the suspended chain conveyor system including conveyor tracks, suspended chains, and such automated conveyance devices, installed between a picking area and a packaging area, so that, after receiving an order and completing picking, by the suspended chains and the conveyor tracks conveyance is made to the packaging area. Herein, conveyance tracks may include multiple lines, the conveyance starting point of each conveyance track line corresponding to a location where a picking area is present, and endpoint corresponding to a location where a packaging area is present. After some particular picking personnel receives a picking task, and after the corresponding products have undergone operations such as weighing and the like, they may be loaded into preset picking containers such as packaging bags, and hung onto the suspended chains. Then, corresponding conveyance tracks may automatically convey picking containers having corresponding products to a packaging area, undergoing packaging processing at the packaging area, including undergoing packaging using packing containers and the like, then undergoing delivery by delivery personnel. This way, picking personnel need only perform picking, hanging the products upon suspended chains, and such operations, the products being sent from the picking area to a packaging area without the need for manual labor; therefore, work efficiency may be improved.

In a small physical storefront, or in situations where orders are small in number, there may be one packaging area, and so, all picking containers output from picking may be delivered to a same packaging area to undergo packaging operations. However, considering that if the number of users increases, the number of orders will constantly increase, in such situations facing high-volume orders, an efficiency bottleneck may yet result from executing packaging in a same packaging area. Therefore, to further improve the efficiency of operations such as picking, packaging and the like, to ensure timely delivery, the technical solutions provided herein may also have multiple packaging areas. This is to say, within a physical storefront, multiple picking areas and multiple packaging areas may be included, or, this may refer to multiple “junctions” of a same packaging area, and in the latter scenario, in a scenario of a same packaging area with multiple “junctions,” a packaging area is still essentially divided into multiple sub-areas, work in each sub-area being independent, therefore, according to example embodiments of the present disclosure, universally called as multiple packaging areas. This is to say, picking and packaging may each be dispersed among multiple different areas and performed synchronously, thus improving the efficiency of picking and packaging.

Herein, in a scenario of multiple picking areas and multiple packaging areas, only after each picking task of a same wave has reached a packaging area, can particular packaging tasks be performed. To this end, the solutions provided herein may further include a control system, where the control system may control the flow direction of picking results being conveyed on suspended chains, so that picking results of different picking tasks in a same wave “converge,” and are delivered to a same packaging area to undergo packaging operations.

This is to say, in the above-mentioned “separate picking, converging packaging” case, by dividing a store into different work areas, with the support of suspended chain systems, highly efficient processing operations pertaining to picking, packaging and the like may be implemented, achieving significant impact upon ensuring timely delivery.

In the actual application of the above-mentioned system, the capability of a physical storefront to process orders, in theory, may still be restricted by the convergence capability of suspended chain hardware. Therefore, conflict between the maximum item quantity that suspended chain hardware can support and the output capability required by business becomes a new problem to be considered. To this end, the case of “integrated picking and packaging” is advanced.

In the case of “integrated picking and packaging,” first, building from the aforementioned case of “separate picking, converging packaging,” one or more special picking areas may be provided, having the distinction that several particular kinds of products may be stored therein, these products being “hot products” that have been predicted through certain algorithms and such methods (for example, predicted based on certain holidays, weather, and the like), or being “bargains” designated within a store, and the like. These particular products being placed at a same picking area, as there exist some customers who habitually exclusively order some “hot products,” “bargains,” and the like, product objects among the orders of some customers may all hit upon the above-mentioned special picking area. And so, in executing order merge processing of orders, in a targeted manner those orders that all hit upon the special picking area may be combined as a same wave (alternatively, this may occur upon conditions such as delivery time, address and the like being satisfied). This is to say, each order within such a wave has a common distinction: products and such corresponding to all data objects in the orders are all located within a same picking area. This way, the wave will not be divided into multiple picking tasks, and a single picking task will be generated, allowing the picking personnel of the special picking area to execute the picking operation.

In actual applications, if picking areas are not specially related by “hot products,” “bargains” and the like, but are rather normal picking areas used to store certain categories of data objects, there may still exist situations where data objects to be picked within a wave all hit upon a same picking area. If such objects are delivered to a packaging area by the aforementioned suspended chain system to undergo packaging, some degree of redundancy results causing suspended chain system resources to be wasted. To this end, in the case of “integrated picking and packaging” provided herein, targeting the above-mentioned situation, operations of both the picking and packaging steps may be executed directly in the picking area, without further delivery to a packaging area, and without occupying suspended chain system resources, and delivery personnel may retrieve packaging results directly from the picking area.

By the above-mentioned “integrated picking and packaging” method, processing of some orders may be achieved without needing to occupy suspended chain resources; therefore, waste of suspended chain resources is avoided, and suspended chain resources may provide effective support in situations of actual need.

In actual applications, often the aforementioned two types of cases coexist, and in the process of order merge processing, if conforming to the requirements of “integrated picking and packaging” for orders, a single picking task may be generated for a wave undergoing picking and packaging by the combined “integrated picking and packaging” process, and picking and packaging operations are completed at a corresponding picking area. If not conforming to the requirements of “integrated picking and packaging” for orders, that is, data objects of a same order are distributed among different picking areas, for a wave undergoing picking and packaging by the combined “separate picking, converging packaging” process, multiple picking tasks are generated targeting a same wave, and after multiple picking operations are completed at multiple picking areas, delivery is performed by a suspended chain system, converging at a same packaging area to undergo packaging.

Through both cases coexisting, the timeliness of delivery may be further ensured. However, since both cases coexist, situations where a same picking personnel receives multiple different types of picking tasks may occur. For example, some picking personnel is responsible for products within a certain “hot product” picking area undergoing picking, and the picking personnel may receive some picking tasks of the type “integrated picking and packaging” (abbreviated as “integrated”); additionally, since within some orders situations where some data objects hit upon the picking area occur, and are merged into a wave of the type “separate picking, converging packaging” (abbreviated as “converging”), now, the picking personnel may also be allocated to picking tasks of the “converging” type. This is to say, a same picking personnel may be allocated to different types of picking tasks, and in situations of many concurrent orders, a same picking personnel dealing with different picking tasks may result in queuing. Picking personnel may need to successively process one by one based on the times of picking tasks, or, according to a certain task priority, prioritize picking tasks of some particular type; for example, prioritizing processing picking tasks of the “integrated” type, and so on.

Overall, whether executing in a successive order according to time, or according to priorities, situations that result in backlogs for some picking tasks may result. However, within waves of the “converging” type, packaging personnel need to await the picking results of all picking tasks to be sent to a packaging area to execute packaging operations, which may result in the following phenomenon. Supposing that a “converging” wave is divided into three picking tasks, wherein, picking tasks A and B have already been completed and delivered to a packaging area, and picking task C is completed late by picking personnel, the reason being that before the picking personnel can process the task, the picking personnel must process other tasks, for example, of “integrated” type and the like, because “integrated” tasks require the picking personnel to execute more processes, including picking, weighing, packaging, code scanning and the like. Therefore, considerable time is also expended, so that picking task C being delayed results in packaging personnel, despite having already received the results of picking tasks A and B, being unable to execute packaging operations. In one aspect, this impacts ensuring timeliness of delivering the wave, and in another aspect, this causes products to accumulate within a packaging area, not only occupying space within the packaging area, but also resulting in confusion in the packaging operations of packaging personnel, increasing the likelihood of errors. Additionally, since a same picking personnel may receive multiple different types of picking tasks, therefore, a picking personnel in the process of executing tasks, may often switch between executing different types, with different picking tasks requiring picking personnel to execute different operations; therefore, problems such as switching between types of tasks resulting in errors or resulting in decreased operational efficiency, and the like, may arise.

This is to say, according to technical solutions corresponding to practical settings provided by example embodiments of the present disclosure, in situations where multiple different types of picking tasks coexist, efficiency of linked operations such as picking, packaging and the like may be further improved, avoiding situations of waiting at packaging areas and reducing likelihood of errors.

To achieve the above-mentioned goals, in cases provided by example embodiments of the present disclosure, picking personnel within a store may undergo binding by different types of picking tasks, which is to say, multiple different picking areas may exist within a store, each different picking area being outfitted with multiple different picking personnel. If it is possible for different types of picking tasks to coexist in some picking area, multiple picking personnel corresponding to the picking area may be bound with different types of picking tasks, causing some picking personnel to exclusively execute a first type of picking task, and some picking personnel to exclusively execute a second type of picking task. If more types of picking tasks exist, by the above-mentioned process picking personnel and the like may be allocated to exclusively execute other types of tasks. By this process, a same picking personnel may be caused to execute a same type of picking task as much as possible, becoming an “experienced worker” with regard to this type of picking task, to improve work efficiency. Furthermore, likelihood of errors may be reduced as the same picking personnel can be avoided from switching between different types of picking tasks. Additionally, with regard to situations where “integrated” tasks and “converging” tasks coexist, since picking personnel exclusively executing “converging” tasks have been specified, “converging” type tasks are only allocated to picking personnel having a binding relationship to this type. Therefore, “converging” tasks becoming delayed will not result just because “integrated” type tasks exist, helping to protect the timely delivery of “converging” waves.

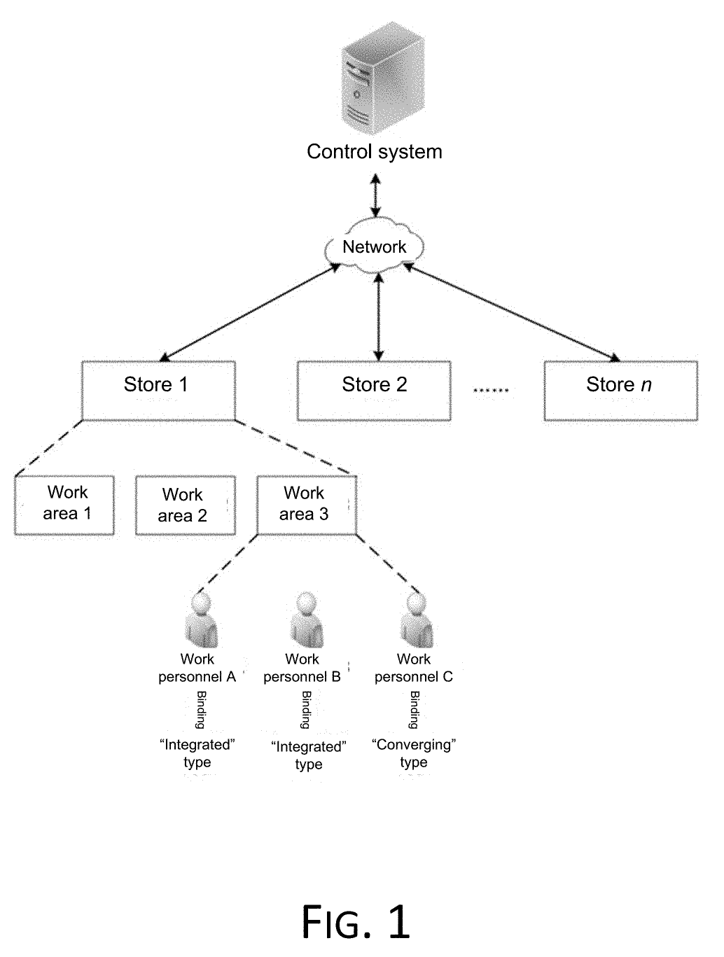

In implementations, since offline storefronts generally have multiple deployed instances, distributed among different geographical locations, to provide users corresponding to the geographical range with delivery service, stock management, generation of picking tasks and the like within each offline storefront may each be completed by a unified control system. As illustrated by FIG. 1, a control system is generally located in the “cloud,” providing information management and such services to multiple offline stores (store 1, store 2, . . . , store n); therefore, technical solutions of example embodiments of the present disclosures may be implemented by the control system.

In particular, a control system may first extract information of work personnel within each offline storefront, including the work type that each work personnel is responsible for (including picking, packaging, and such types), work areas (different picking areas and the like), and such information. In implementations, each store may transmit in unison lists of each work personnel therein and such information, where lists may record information such as the department where each user is present, the work area that each is responsible for, and the like. In actual applications, since work personnel within a store may utilize a “schedule” system, different work personnel of the same posting may rotate duties, and only on-duty work personnel are able to receive work tasks. Therefore, in preferred implementations, log entries may be provided for work personnel within an offline storefront, and each work personnel may, at time of registration, enter their respective offline store, department, responsible work type, work area and such into the system. This way, a work personnel needs to log in to the system, and the system may learn information related to the work personnel, determining whether the work personnel may start work. Then, a particular work personnel may be bound with a corresponding work task type (for example, divided among an “integrated” type, a “converging” type and the like). This is to say, by this process, each time a work personnel logs in, the work personnel may be bound with some work task type by the control system, and after logging out, the corresponding binding relationship may be deleted. With regard to a same work personnel, the bound task type at each login time may be kept consistent as much as possible. By this process a “punch card” mechanism is substantially implemented; aside from facilitating the system extracting basic attribute information of work personnel, as well as information such as whether task allocation may be executed, stores may also be assisted in the function of managing work personnel.

As illustrated by FIG. 1, suppose that within store 1 three work areas are provided for picking work, designated as work area 1, work area 2, and work area 3. Herein, work area 3 is a “hot product” work area, the store having outfitted the work area with three work personnel, designated as work personnel A, B, and C, who have already logged in to the control system. Since multiple types of work tasks may be allocated to the work areas, therefore, the control system may separately bind different work task types to the work personnel related to the work areas, for example, work personnel A and B are bound with the “integrated” type, work personnel C is bound with the “converting” type, and so on. This is to say, in terms of each work area within a store, the above-mentioned binding operations may be executed targeting needed work areas, and if some work area only produces one kind of work task type, the numbers of work personnel allocated to this kind of work area in a store may be relatively reduced, and correspondingly, the control system may not need to perform work task type differentiation and binding operations for some work personnel. Additionally, other stores may perform the above-mentioned type processing, not illustrated in the Figure and which shall not be repeated here.

Particularly at the time of performing binding between personnel and work task types, if the number of work personnel in a same work area and the number of work task types are equal, each work personnel and each work task type may be corresponded one to one; if the number of work personnel is greater than the number of work task types, more flexible processing may be performed. For example, in an initial slate, random allocation may be performed based on information such as a preset ratio, or, at the time of allocation, historical allocation results may be considered; for example, a same work personnel is made to correspond to a same work task type as much as possible. For example, some work personnel A was bound yesterday to the “integrated” type, and so is also bound with the “integrated” type today; and the like. Additionally, binding relationships may be adjusted based on actual order generation incidences, logins and logouts of work personnel, and the like. For example, it is discovered that the number of orders of the “integrated” type significantly increased at some time, and thus work personnel originally bound with the “converging” type are changed to be bound with the “integrated” type, enabling more work personnel to exclusively execute the “integrated” type of tasks, and the like. Or, it is discovered at some time that a work personnel has logged out, and thus the binding relationship of the work personnel is deleted, and at the same time, if needed, the binding relationships corresponding to other work personnel may undergo adjustment. For example, some work area originally has three work personnel, wherein the work task type corresponding to work personnel A and B is the “integrated” type, whereas the work task type corresponding to work personnel C is the “converging” type, and at some time it is discovered that work personnel C has logged out, resulting in there being no work personnel to exclusively execute “converging” type tasks, therefore, the binding relationship of one of work personnel A or B may be revised to correspond to “converging” type, and so on.

In implementations, the control system may maintain a binding relationship table, wherein correspondence relationships between each work personnel and work task type are recorded, this way, when various different types of work tasks are produced, tasks may be allocated based on the relationship table. For example, the format of a relationship table may be as illustrated by Table 1:

TABLE 1

| Work | | Belongs | Respon- | Respon- | |
|---|---|---|---|---|---|
| person- | Belongs to | to depart- | sible for | sible for | Work task |
| nel ID | store ID | ment ID | work type | work area | type |
| 100001 | 20001 | 301 | Picking | Picking | “Integrated” |
| | | | | area A | |
| 100002 | 20001 | 301 | Picking | Picking | “Converging” |
| | | | | area A | |
| 100003 | 20001 | 301 | Picking | Picking | “Integrated” |
| | | | | area B | |
| 100004 | 20001 | 301 | Picking | Picking | “Integrated” |
| | | | | area B | |
| 100005 | 20001 | 301 | Picking | Picking | “Converging” |
| | | | | area B | |
| 100006 | 20002 | 301 | Picking | Picking | “Converging” |
| | | | | area C | |
| . . . | . . . | . . . | . . . | . . . | . . . |

Through particularly stored binding relationships, it is possible to, after particular picking and such work tasks are generated, based on the types of the work tasks, allocate the work tasks to work personnel having actual binding relationships to the types. In actual applications, the control system may also store correspondence relationships between each work area of each store and particular stored data objects, and data objects indicated as needed in transactional orders generated by customer users and information of the store serving them (the store information may be selected by the customer user, or, automatic matching operations may be performed based on the geographical location where a user is present). Therefore, based on the needed data objects, the one or more work areas within the store where the data objects are located may be determined. This is to say, at the time of generating work tasks, aside from determining work task types, a particular store ID, work type, work area identification, and the like are also determined, therefore, at the time of allocating work tasks, in particular corresponding target work personnel may be determined based on the aforementioned Table 1. For example, supposing that some work task needs to be allocated to work area A of store 20001, and the type of the work task is an “integrated” task, thus based on the aforementioned Table 1, the work task may be allocated to work personnel 100001, and so on.

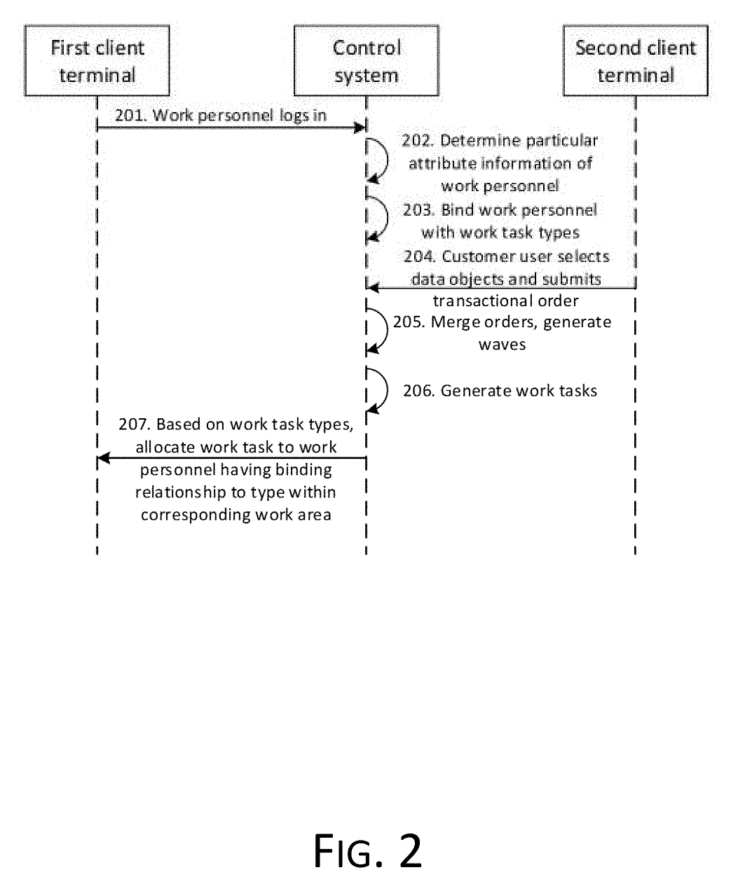

For improved understanding of technical solutions provided by example embodiments of the present disclosure, combining the below with FIG. 2, example embodiments of the present disclosure are introduced in detail for business handling processes by an implementation method 200.

In step 201, a work personnel logs into the control system through a first client terminal.

In step 202, the control system determines particular attribute information of work personnel. In particular, since the control system may store particular attribute information provided by work personnel at a time of registration, including store, department, work type, work area, and the like to which the work personnel belong, a work personnel need only log in to the control system for the control system to learn the particular attribute information.

In step 203, the control system binds work personnel with work task types. In this step, based on the particular situation of each work area within each store, the above-mentioned binding operation may be executed in necessary situations.

In step 204, a customer user selects data objects and submits a transactional order through a second client terminal.

In step 205, the control system performs merge operations upon transactional orders within a store, generating one or more waves, where different waves may correspond to different types, for example, the “integrated” type, the “converging” type, and so on.

In step 206, the control system generates work tasks targeting each wave, wherein, based on type differences between waves, the generated work tasks also have different types. For example, with regard to a wave of the “integrated” type, only one work task may be generated, the type of the task being the “integrated” type; with regard to a wave of the “converging” type, multiple work tasks may be generated, the task type corresponding to each work task being the “converging” type; each work task corresponding to a same work area;

In step 207, based on the work task type, for the corresponding store, the work task is allocated to work personnel having binding relationships to the type within the corresponding work area. This is to say, the “integrated” type of work task is allocated to work personnel having a binding relationship to the “integrated” type, the “converging” type of work task is allocated to work personnel having a binding relationship to the “converging” type, and so on. Correspondingly, after work personnel claims a work task, based on differences between work task types, the first client terminal may present different operational interfaces, and then, work personnel may perform work according to instructions in the operational interface. For example, work personnel executing the “integrated” type work tasks, may complete picking, packaging, code scanning, and the like operations at a corresponding work area, and await receipt by delivery personnel; work personnel executing “converging” type work tasks, may execute picking operations at some present work area, and by a suspended chain system send to a packaging area, and work personnel of the packaging area may execute packaging work after receiving picking results of each picking task of the same wave.

Below, respectively from the perspective of a control system server in communication with a first client terminal of work personnel, particular technical solutions provided by example embodiments of the present disclosure are introduced. Herein, the first client terminal may exist in the form of an independent app, or may exist in the form of a webpage, or may exist in other alternative forms, not to be limited thereto.

### First Example Embodiment

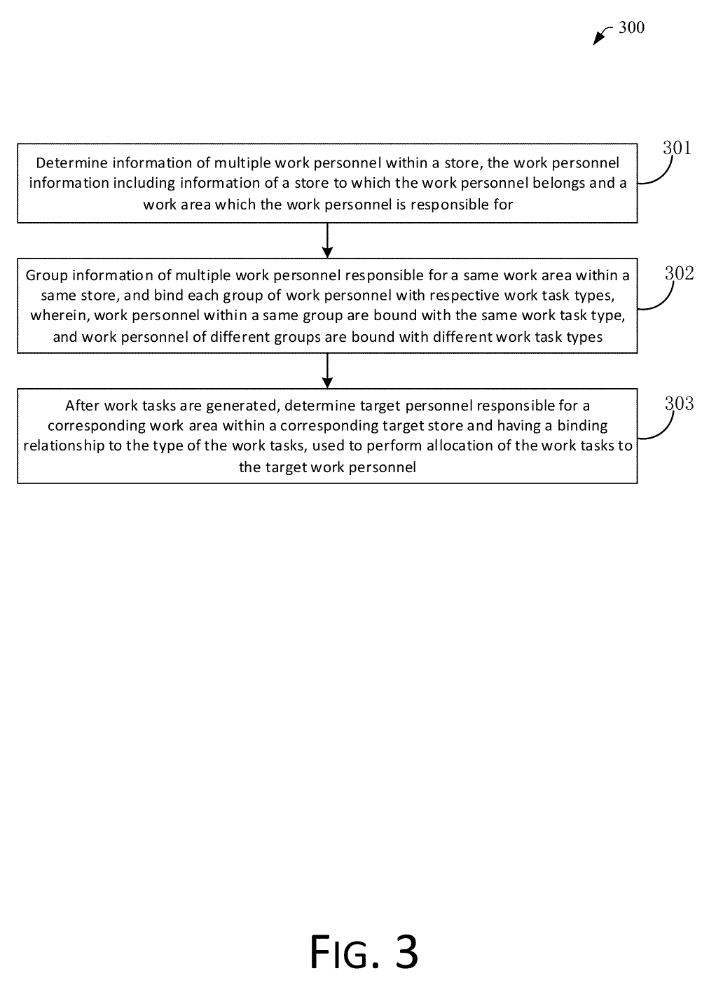

The first example embodiment first from a control system server provides a work task allocation method 300. Referring to FIG. 3, the method 300 may particularly include:

In step 301, determining information of multiple work personnel within a store, the work personnel information including information of a store to which the work personnel belongs and information of work area which the work personnel is responsible for.

In implementations, the control system may determine information of work personnel within each store by multiple processes, for example, one such process may be a store client terminal transmitting in unison particular attribute information of each work personnel, or, as previously described, a user login system may be utilized, where for each work personnel undergoing registration at the control system, some particular attribute information is entered, and is stored by the control system, this way, each time work personnel logs in, the system may learn the particular attribute information of the work personnel.

In step 302, grouping information of work personnel within a same store and responsible for a same work area based on differences in work task types, and each work personnel and a respective work task type undergo binding, wherein, work personnel of a same group are bound with the same work task type, and work personnel of different groups are bound with different work task types.

After determining work personnel information, particular work personnel may be bound with particular work task types, wherein, a work personnel may be bound with a work task type, for example, whether the “integrated” type, the “converging” type, and the like.

In implementations, work personnel information may be grouped based on the number of work personnel within a same store and responsible for a same work area and the number of work task types. Herein, if the number of work personnel and the number of work task types are equal, then each work personnel of the same store and responsible for the same work area are grouped into one group, and binding is performed between each work personnel and each work task type by a one-to-one correspondence. If the number of work personnel is greater than the number of work task types, based on a preset allocation ratio, work personnel information is grouped. With regard to the latter, after work personnel allocation is performed for each work task type, actual generation incidences for each type of work task may be counted, and based on the counting results, binding relationships between work personnel and work task types undergo adjustment, achieving flexible binding. At the time of determining what particular work task types particular work personnel are bound with, determination may be made by reference to historical binding information, causing a same work personnel to be bound with a same work task type as much as possible.

Herein, in a special situation, a same store may include at least one first work area (for example, a work area where in particular the previously described “hot products,” “bargains” and such are present, and the like), the first work area being utilized to store predetermined specific data objects (“hot products,” “bargains” and the like), such that the likelihood of each data object related to a same transactional order being a specific data object in the same first work area exceeds a preset threshold. Accordingly, work tasks related to such a first work area generally have multiple types, and other normal work areas are oftentimes all executing “converging” types of tasks. Therefore, particularly at the time of performing binding, information of multiple work personnel within the store responsible for the first work area undergo grouping based on differences between work task types, and each group of work personnel and respective work task type undergo binding, while for work personnel of other, normal work areas, the above-mentioned binding operations may not need to be executed.

In step 303, after work tasks are generated, determining target work personnel within the target store, responsible for a corresponding target work area, and having a binding relationship to the types of the work tasks, used to perform allocation of the work tasks to the target work personnel.

Herein, particular work tasks may be generated based on the situation of transactional orders submitted by customer users. In particular, transactional orders within a same store may undergo merge operations, generating one or more waves, where different waves may correspond to different types. In particular, at the time of order merging, the transactional orders whose related data objects are the specific data objects are merged into a first type of wave, and the transactional orders whose related data objects include some of the specific data objects or do not include the specific data objects are merged into a second type of wave. Based on the type of the wave and the related data objects, work tasks may be generated, wherein, the work task type and the type of the wave correspond to each other. Also, based on differences between wave types, correspondingly generated work tasks may have different types, for example, types may include “integrated” types, “converging” types, and the like; as well, each work task and a particular work area correspond to each other. Then, based on work task type binding information of each work personnel within the corresponding store and within the corresponding work area, the work personnel to execute the current work tasks are determined.

For example, supposing that at the time that each transactional order within some targeted store 1 undergoes order merging, two waves are generated, wherein, the first wave is an “integrated” wave, and the second wave is a “converging” wave; at the time of generating work tasks, targeting the first wave, a work task may be generated, the type of the work task being the “integrated” type; supposing that the work task corresponds to work area 3 of the store 1, now, the control system may query the binding relationship corresponding to the work personnel within the store 1 and responsible for work area 3, and through the query learn that work personnel A and B within the work area 3 are bound with the “integrated” type, therefore, the work task may be allocated to work personnel A or B, and when specifically choosing, may be determined based on each respective allocated task volume and the like. Additionally, at the time of generating work tasks based on the second wave, multiple work tasks may be generated, the type of each work task being the “converging” type, different work tasks corresponding to different work areas. Supposing that herein one work task of converging type corresponds to work area 3, and through a query it is determined that work personnel C within work area 3 is bound with the “converging” type, therefore, the work task of the “converging” type may be allocated to work personnel C. With regard to other work tasks of the wave, allocation may be performed by a similar process. If within a work area corresponding to a certain work task, binding of work personnel with work task types has not taken place, random allocation, or allocation by the amount of tasks, etc., may be performed.

It should be said that, “work” according to example embodiments of the present disclosure may generally refer to “picking” type work, correspondingly, work tasks may refer to picking tasks, and work task type refers to work tasks of a same kind of work type (the same as picking tasks); based on differences in manner of task execution, different task types are distinguished. Example embodiments of the present invention also provide example illustrations of “integrated” type, “converging” type, and so on.

In summary, according to example embodiments of the present invention, by binding a particular work task type to work personnel, a same work area has work personnel exclusively responsible for performing each different type of work task, and at the time of allocating work tasks, allocation may be performed based on the above-mentioned binding relationships, prioritizing allocation where they exist. By this process, the work tasks executed by each work personnel are simplified, avoiding a backlog of multiple different types of work tasks at a single work personnel, resulting in phenomenon such as waiting, decreased efficiency and the like.

### Second Example Embodiment

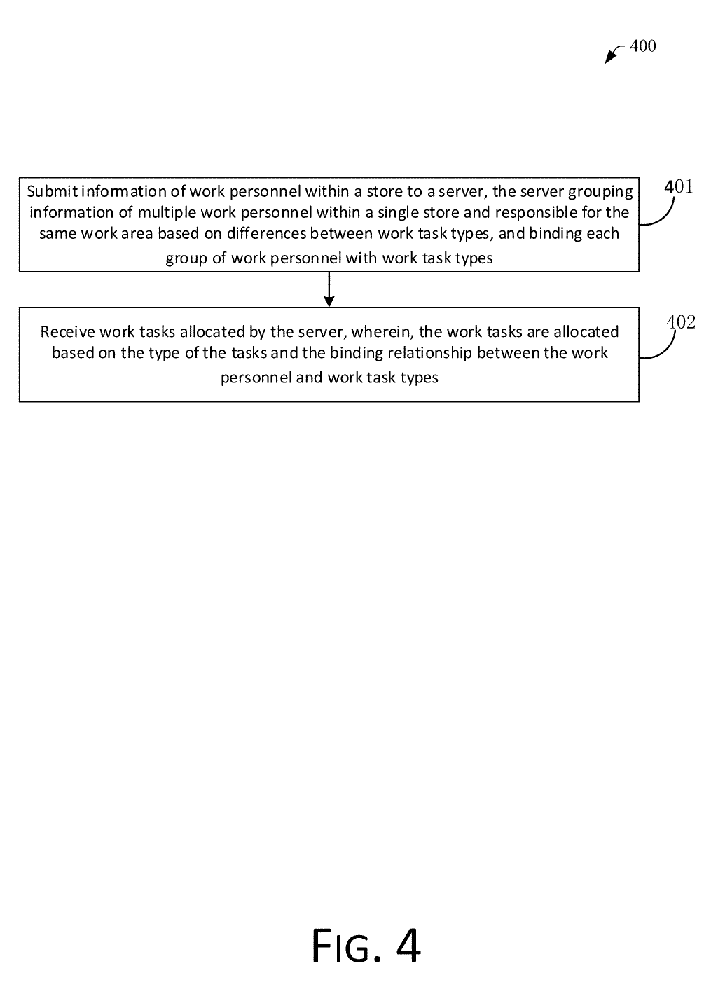

The second example embodiment corresponds to the first example embodiment, from the perspective of the first client terminal, a work task claiming method 400 is provided. Referring to FIG. 4, the method 400 may include:

In step 401, submitting information of work personnel within a store to a server, the server groups information of multiple work personnel within a same store and responsible for a same work area based on differences in work task types, and binds work personnel of each group and work task types, wherein, work personnel within a same group are bound with the same work task type, and work personnel of different groups are bound with different work task types, the work personnel information including information of the store to which they belong and the work area which they are responsible for.

In step 402, receiving work tasks allocated by the server, wherein, the work tasks are allocated based on the types of the tasks and the binding relationship between the work personnel and work task types.

With regard to particular implementations of the second example embodiment, the aforementioned first example embodiment as introduced in other parts may be referred to, and shall not be repeated herein.

### Third Example Embodiment

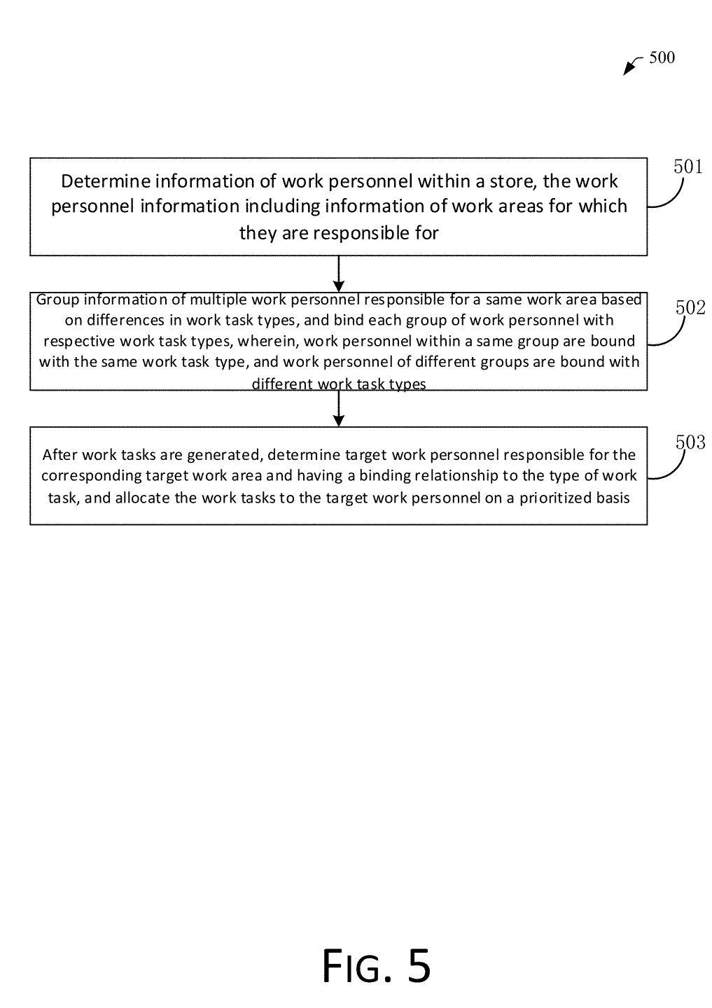

In the aforementioned first example embodiment and second example embodiment, both utilize a cloud control system to control task allocation within each store in unison, and in actual applications, stores may also be controlled independently. Now, control systems may be deployed in each store, and correspondingly, the third example embodiment from the perspective of the control system, provides a work task allocation method 500. Particularly, referring to FIG. 5, the method 500 may include:

In step 501, determining information of work personnel within a store, the work personnel information including information of work areas for which they are responsible for.

In step 502, grouping information of multiple work personnel responsible for a same work area based on differences in work task types, and binding each group of work personnel with respective work task types, wherein, work personnel within a same group are bound with the same work task type, and work personnel of different groups are bound with different work task types.

In step 503, after work tasks are generated, determining target work personnel responsible for the corresponding target work area(s) and having a binding relationship to the types of work tasks, and allocating the work tasks to the target work personnel on a prioritized basis.

With regard to implementations of each step of the third example embodiment, the aforementioned first example embodiment as introduced in other parts may be referred to, and shall not be repeated herein.

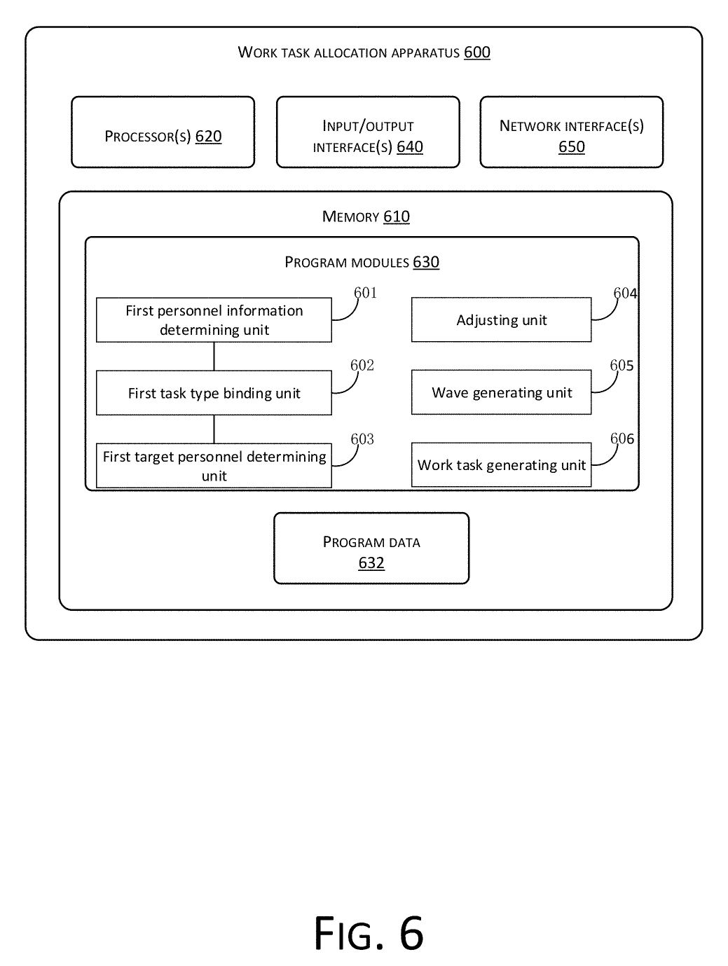

With regard to the first example embodiment, example embodiments of the present disclosure also provide a work task allocation apparatus 600. Referring to FIG. 6, the apparatus 600 may include: memory 610, one or more processors 620, one or more input/output interfaces 640, and one or more network interfaces 650. The apparatus 600 may further include a first personnel information determining unit 601, a first task type binding unit 602, and a first target personnel determining unit 603.

Memory 610 is operative to store program instructions and/or data.

One or more processors 620, through reading program instructions and/or data stored on memory 610, is operative to execute processes as follows:

The first personnel information determining unit 601 is stored in the memory 610 and executable by the one or more processors 620 to cause the one or more processors 620 to determine information of work personnel within multiple stores, the work personnel information including information of stores to which they belong and work areas to which they are responsible for;

The first task type binding unit 602 is stored in the memory 610 and executable by the one or more processors 620 to cause the one or more processors 620 to group information of multiple work personnel within a same store and responsible for a same work area based on differences in work task types, and to bind each group of work personnel with a respective work task type, wherein, work personnel of a same group are bound with the same work task type, and work personnel of different groups are bound with different work task types;

The first target personnel determining unit 603 is stored in the memory 610 and executable by the one or more processors 620 to cause the one or more processors 620 to, after work tasks are generated, determine target work personnel responsible for corresponding work area(s) within a corresponding store and having a binding relationship with the types of work tasks, and to allocate the work tasks to the target work personnel.

Herein, the first task type binding unit 602 may particularly include:

A grouping unit stored in the memory 610 and executable by the one or more processors 620 to cause the one or more processors 620 to group work personnel information based on the number of work personnel within a same store and responsible for a same work area and the number of work task types.

Upon particular implementation, the grouping unit may particularly be executable by the one or more processors 620 to cause the one or more processors 620 to:

If the number of work personnel and the number of work task types are equal, forming each work personnel within a same store and responsible for the work area as one group.

Or, the grouping unit may be executable by the one or more processors 620 to cause the one or more processors 620 to:

If the number of work personnel is greater than the number of work task types, grouping work personnel information based on a preset allocation ratio.

Additionally, the apparatus 600 may further include:

An adjusting unit 604 stored in the memory 610 and executable by the one or more processors 620 to cause the one or more processors 620 to, after each group of work personnel and respective work task types has undergone binding, count the actual generation situation of each type of work task, and adjust binding relationships between work personnel and work task types based on counting results.

In particular, the first task type binding unit 602 may particularly be executable by the one or more processors 620 to cause the one or more processors 620 to:

Based on historical binding information of each work personnel, determine particular work task types bound to work personnel.

Herein, if at least one first work area is included within a same store, and the first work area is utilized to store specific data objects, the likelihood that data objects related to a same transactional order are specific data objects located at a same first work area exceeds a threshold;

The first task type binding unit 602 may particular be executable by the one or more processors 620 to cause the one or more processors 620 to:

Group information of the multiple work personnel within the store and responsible for the first work area based on differences between work task types, and perform binding between each group of work personnel and a respective work task type.

Additionally, the apparatus 600 may further include:

A wave generating unit 605 stored in the memory 610 and executable by the one or more processors 620 to cause the one or more processors 620 to perform order merging based on transactional order information corresponding to a same store, and generate waves; wherein, at the time of order merging, transactional orders whose related data objects are the specific data objects are merged as a first type of wave, and transactional orders whose related data objects include some of the specific data objects or which do not include the specific data objects are merged as a second type of wave;

A work task generating unit 606 stored in the memory 610 and executable by the one or more processors 620 to cause the one or more processors 620 to generate work tasks based on the type of the wave and the related data objects, wherein, the work task type and the type of the wave correspond to each other.

An embodiment of the present application further discloses a computer readable storage medium, wherein the computer readable storage medium stores instructions which, when running on a computer, enable the computer to perform the processes described above.

The memory 610 may include a form of computer readable media such as a volatile memory, a random access memory (RAM) and/or a non-volatile memory, for example, a read-only memory (ROM) or a flash RAM. The memory 610 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 610 may include program modules 630 and program data 632. The program modules 630 may include one or more of the units as described in above.

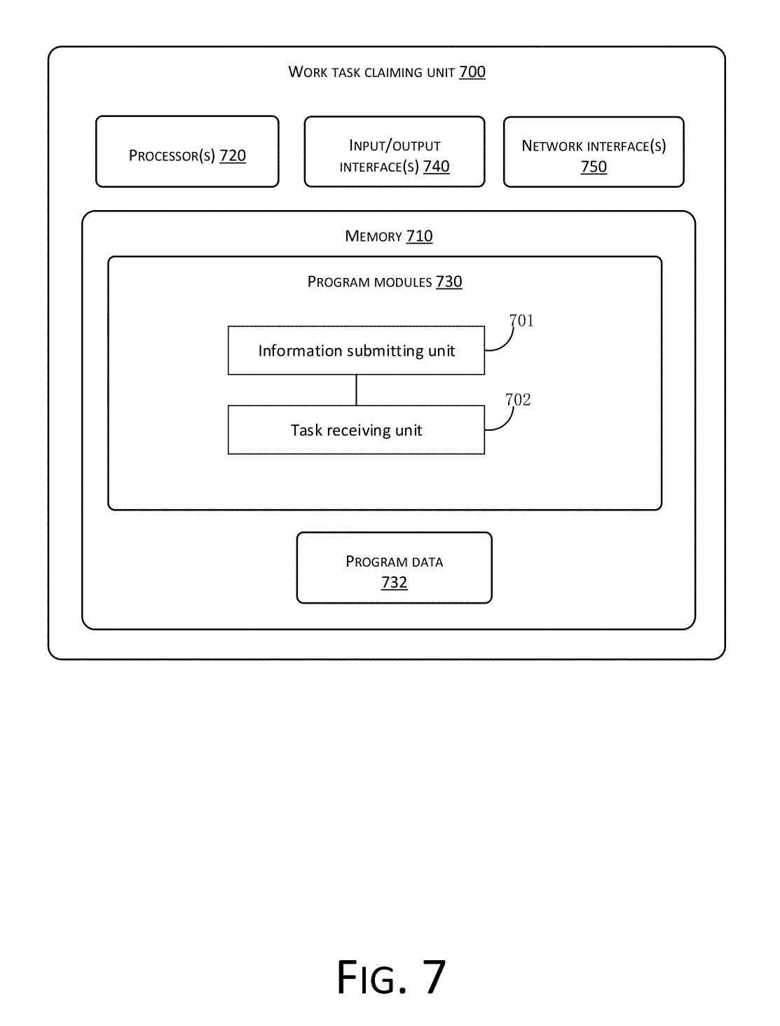

With regard to the second example embodiment, examples of the present disclosure further provide a work task claiming apparatus 700. Referring to FIG. 7, the apparatus may include: memory 710, one or more processors 720, one or more input/output interfaces 740, and one or more network interfaces 750. The apparatus 700 may further include an information submitting unit 701, and a task receiving unit 702.

Memory 710 is operative to store program instructions and/or data.

One or more processors 720, through reading program instructions and/or data stored on memory 710, is operative to execute processes as follows:

The information submitting unit 701 is stored in the memory 710 and executable by the one or more processors 720 to cause the one or more network interfaces 750 to submit information of work personnel within a store to a server, causing the server to group information of multiple work personnel within a same store and responsible for a same work area based on differences between work task types, and perform binding between each work personnel group and respective work task type, wherein, work personnel within a same group are bound with the same work task type, and work personnel of different groups are bound with different work task types, the work personnel information including information of stores to which they belong and work areas which they are responsible for.

A task receiving unit 702 is stored in the memory 710 and executable by the one or more processors 720 to cause the one or more network interfaces 750 to receive work tasks allocated by the server, wherein, the work tasks are allocated based on the types of the tasks and binding relationships between the work personnel and the work task types.

An embodiment of the present application further discloses a computer readable storage medium, wherein the computer readable storage medium stores instructions which, when running on a computer, enable the computer to perform the processes described above.

The memory 710 may include a form of computer readable media such as a volatile memory, a random access memory (RAM) and/or a non-volatile memory, for example, a read-only memory (ROM) or a flash RAM. The memory 710 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 710 may include program modules 730 and program data 732. The program modules 730 may include one or more of the units as described in above.

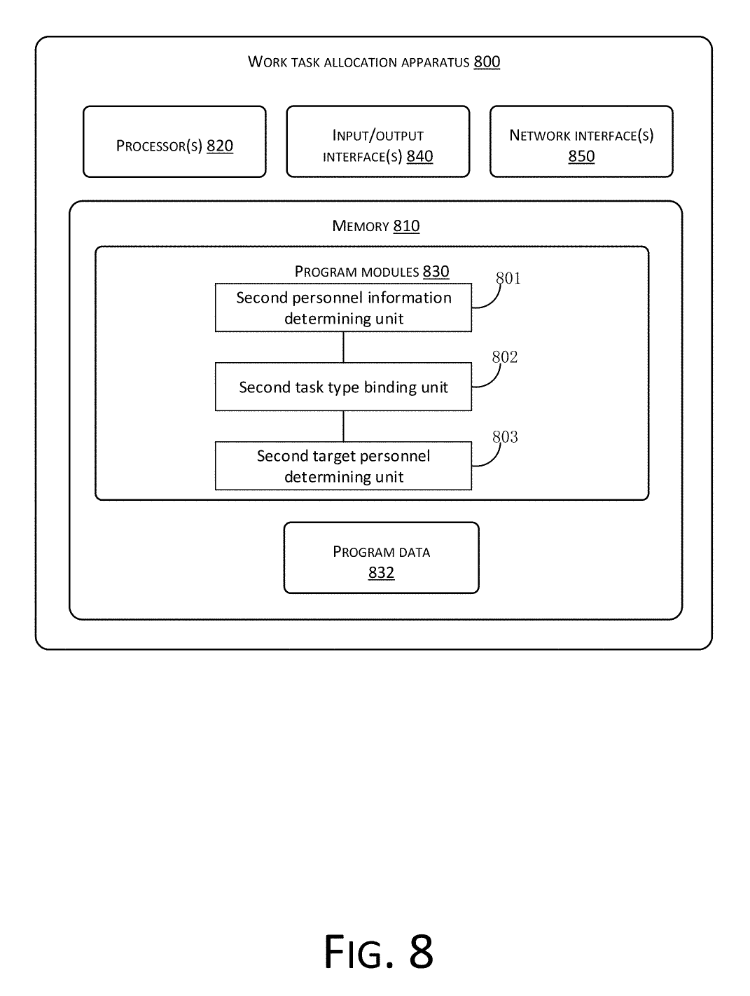

Corresponding to the third example embodiment, embodiments of the present disclosure further provide a work task allocation apparatus, referring to FIG. 8, the apparatus may include: memory 810, one or more processors 820, one or more input/output interfaces 840, and one or more network interfaces 850. The apparatus 800 may further include a second personnel information determining unit 801, a second task type binding unit 802, and a second target personnel determining unit 803.

The second personnel information determining unit 801 is stored in the memory 810 and is executable by the one or more processors 820 to cause the one or more processors 820 to determine information of work personnel within a store, the work personnel information including information of the work areas they are responsible for.

The second task type binding unit 802 is stored in the memory 810 and is executable by the one or more processors 820 to cause the one or more processors 820 to group information of multiple work personnel responsible for a same work area based on differences between work task types, and bind each group of work personnel with respective work task types, wherein, work personnel within a same group are bound with the same work task type, and work personnel of different groups are bound with different work task types.

The second target personnel determining unit 803 is stored in the memory 810 and is executable by the one or more processors 820 to cause the one or more processors 820 to, after work tasks are generated, determine target work personnel responsible for corresponding work area(s) and having a binding relationship with the types of work tasks, and allocating the work tasks to the target work personnel on a prioritized basis.

An embodiment of the present application further discloses a computer readable storage medium, wherein the computer readable storage medium stores instructions which, when running on a computer, enable the computer to perform the processes described above.

The memory 810 may include a form of computer readable media such as a volatile memory, a random access memory (RAM) and/or a non-volatile memory, for example, a read-only memory (ROM) or a flash RAM. The memory 810 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 810 may include program modules 830 and program data 832. The program modules 830 may include one or more of the units as described in above.

Additionally, example embodiments of the present disclosure further provide a computing system, including:

One or more processors; and

Memory related to the one or more processors, the memory operative to store program instructions, the program instructions upon being read and executed by the one or more processors, execute the following operations:

Determine information of work personnel within multiple stores, the work personnel information including information of the stores to which they belong and the work areas they are responsible for;

Group information of multiple work personnel within a same store and responsible for a same work area based on differences between work task types, and bind each group of work personnel with respective work task types, wherein, work personnel within a same group are bound with the same work task type, and work personnel of different groups are bound with different work task types;

After work tasks are generated, determine target work personnel corresponding to target work area(s) within a target store and having a binding relationship to the types of the work tasks, and operative for the allocation of the target work personnel to the work tasks.

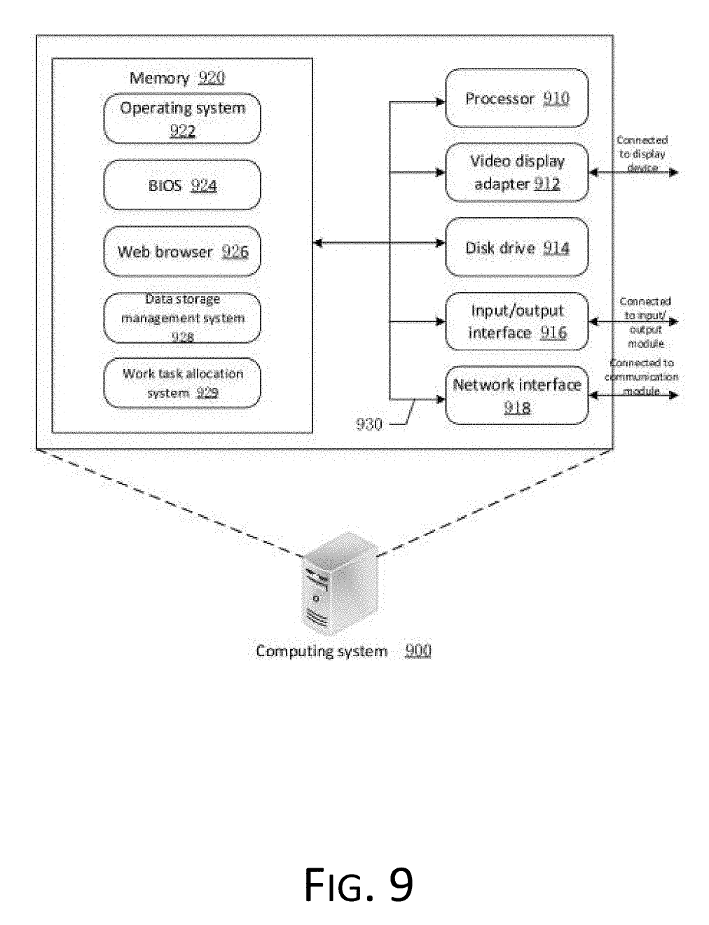

Herein, FIG. 9 is an exemplary illustration of the structure of a computing system, which may particularly include a processor 910, a video display adapter 912, a disk drive 914, an input/output interface 916, a network interface 918, and memory 920. The above-mentioned processor 910, video display adapter 912, disk drive 914, input/output interface 916, network interface 918, and memory 920 may be connected to each other in communication through a communication bus 930.

Herein, the processor 910 may be implemented utilizing a universal CPU (central processing unit), microprocessor, employing an ASIC (application specific integrated circuit), or one or more integrated circuits and such methods, operative to execute related programs, implementing technical solutions provided by the present disclosure.

Memory 920 may be implemented utilizing ROM (read only memory), RAM (random access memory), static storage devices, dynamic storage devices, and such forms. Memory 920 may store an operating system 922 operative to control the operation of the computing system 900, operative to control the low-level operations of the basic input output system (BIOS) 924 of the computing system 900. Additionally, memory 920 may store a web browser 926, a data storage management system 928, a work task allocation system 929 and the like. The above-mentioned work task allocation system 929 is an application program particularly implementing the operation of each aforementioned step according to example embodiments of the present disclosure. In summary, where technical solutions provided by the present disclosure are implemented through software or hardware, corresponding program code is stored in memory 920, and may be called and executed by processor 910.

Video display adapter 912 is operative to connect a display device, implementing display of information.

Input/output interface 916 is operative to connect an input/output module, implementing information input and output. The input/output module may be components configured within a device (not illustrated in the Figure), or may be external to the device providing corresponding functionality. Herein an input device may include a keyboard, a mouse, a touchscreen, a microphone, various sensors, and the like, and an output device may include a display device, a speaker device, a vibration device, an indicator lamp, and the like.

A network interface 918 is operative to connect a communication module (not illustrated in the Figure), implementing interactions between the present device and other devices. Herein, a communication module may implement communication through a wired method (such as USB, Ethernet and the like), or through a wireless method (such as a mobile network, Wi-Fi, Bluetooth and the like).

The bus 930 includes a route, transmitting information between each component (such as processor 910, video display adapter 912, disk drive 914, input/output interface 916, network interface 918, memory 920) of the device.

Additionally, the computing system 900 may from a conditional information database 941 received from virtual resource objects obtain particular received conditional information, operative to perform conditional judgment, and the like.

It should be said that, in spite of the above-mentioned device showing only processor 910, video display adapter 912, disk drive 914, input/output interface 916, network interface 918, memory 920, bus 930 and the like, but in particular implementation processes, the device may also include other components required to realize normal operation. Additionally, persons skilled in the present field may understand that the above-mentioned device may also include components required to realize schemes of the present disclosure, not necessarily including all components illustrated by the Figure.

Through the implementations as described above it may be known that, persons skilled in the art may clearly understand that the present disclosure may be implemented in a fashion assisted by software plus commonly used hardware platforms. Based on this understanding, the technical solutions of the present disclosure essentially, or those parts contributing to existing technologies, may be implemented in the form of software products, where the computer software products may be stored in a storage media, such as ROM/RAM, disk, optical disc, and the like, including some instructions that cause a computer device (which may be a personal computer, server, or network equipment, and the like) to execute methods described by each example embodiment or certain parts of embodiments of the present disclosure.

The example embodiments in this specification are described progressively, each example embodiment emphasizes a part different from other example embodiments, and identical or similar parts of the example embodiments may be obtained with reference to each other. Especially, with regard to systems or example embodiments of systems, due to essentially being similar to method example embodiments, are thus described relatively simply, and may be explained with reference to the related parts of the method example embodiments. The above-described systems and example embodiments of systems are merely schematics, wherein the units explained as separate parts may be or may not be physically separate, the components displayed as units may or may not be physical units, and may be located in a location, or may be distributed among multiple networked units. Based on actual requirements, selected parts herein, or all units, may be used to implement the schemes of the present disclosure. Persons skilled in the art, without the use of creative effort, may understand and implement such.

By the work task allocation methods, apparatuses, and computing systems provided by the present disclosure, simply introduced herein, the present disclosure utilizes particular examples to explain the principles and implementations of the present disclosure, where the explanations of the above example embodiments are merely utilized to assist in understanding the methods and core ideas of the present disclosure; at the same time, with regard to persons of ordinary skill in the art, based on the ideas of the present disclosure, may make modifications to the implementations and fields of application of the example embodiments. In summary, the contents of the present disclosure shall not be understood as limited to the present disclosure.

The present disclosure may further be understood with clauses as follows.

Clause 1. A work task allocation method, comprising:

determining information of work personnel within multiple stores, the work personnel information including information of stores they belong to and work areas they are responsible for;

grouping information of multiple work personnel responsible for a same work area within a same store based on differences in work task types, and binding each group of work personnel with respective work task types, wherein work personnel within a same group are bound with the same work task type, and work personnel of different groups are bound with different work task types; and

after work tasks are generated, determining target work personnel responsible for the corresponding target work area(s) in a corresponding store and having a binding relationship to the types of work tasks, and allocating the work tasks to the target work personnel on a prioritized basis.

Clause 2. The method of clause 1, wherein grouping information of multiple work personnel responsible for a same work area within a same store based on differences in work task types comprises:

grouping work personnel information based on the number of work personnel within a same store and responsible for a same work area and the number of work task types.

Clause 3. The method of clause 2, wherein grouping work personnel information based on the number of work personnel within a same store and responsible for a same work area and the number of work task types comprises:

if the number of work personnel and the number of work task types are equal, forming each work personnel of the same store and responsible for the same work area as one group.

Clause 4. The method of clause 2, wherein grouping work personnel information based on the number of work personnel within a same store and responsible for a same work area and the number of work task types comprises:

if the number of work personnel is greater than the number of work task types, grouping work personnel ratio based on a preset allocation ratio.

Clause 5. The method of clause 4, further including, after binding each group of work personnel with respective work task types:

counting actual generation incidences for each type of work task, and adjusting, based on the counting results, binding relationships between work personnel and work task types.

Clause 6. The method of one of the clauses 1 to 5, wherein binding each group of work personnel with respective work task types comprises:

based on historical binding information of each work personnel, determining the particular work task types that work personnel are bound with.

Clause 7. The method of one of the clauses 1 to 5, wherein at least one first work area is included within a same store, the first work area is utilized to store specific data objects, and the likelihood that data objects related to a same transactional order are specific data objects located at a same first work area exceeds a threshold; and

grouping information of multiple work personnel responsible for a same work area within a same store based on differences in work task types, and binding each group of work personnel with respective work task types, comprises:

grouping information of the multiple work personnel within the store and responsible for the first work area based on differences between work task types, and binding each group of work personnel with respective work task types.

Clause 8. The method of clause 7, further comprising:

merging orders based on transactional order information corresponding to a same store, and generating waves; wherein at the time of order merging, transactional orders whose related data objects are the specific data objects are merged as a first type of wave, and transactional orders whose related data objects include some of the specific data objects or which do not include the specific data objects are merged as a second type of wave; and

generating work tasks based on the type of the wave and the related data objects, wherein the work task type and the type of the wave correspond to each other.

Clause 9. A work task claiming method, comprising:

submitting information of work personnel within a store to a server, the server grouping information of multiple work personnel within a same store and responsible for a same work area based on differences in work task types, and binding work personnel of each group and work task types, wherein work personnel within a same group are bound with the same work task type, and work personnel of different groups are bound with different work task types, the work personnel information including information of the store to which they belong and the work area which they are responsible for; and

receiving work tasks allocated by the server, wherein the work tasks are allocated based on the types of the tasks and the binding relationship between the work personnel and work task types.

Clause 10. A work task allocation method, comprising:

determining information of work personnel within a store, the work personnel information including information of work areas for which they are responsible for;

grouping information of multiple work personnel responsible for a same work area based on differences in work task types, and binding each group of work personnel with respective work task types, wherein work personnel within a same group are bound with the same work task type, and work personnel of different groups are bound with different work task types; and

determining, after work tasks are generated, target work personnel responsible for the corresponding target work area(s) and having a binding relationship to the types of the work tasks, and allocating the work tasks to the target work personnel on a prioritized basis.

Clause 11. A work task allocation apparatus, comprising:

a first personnel information determining unit, operative to determine information of work personnel within multiple stores, the work personnel information including information of stores to which they belong and work areas to which they are responsible for;

a first task type binding unit, operative to group information of multiple work personnel within a same store and responsible for a same work area based on differences in work task types, and to bind each group of work personnel with a respective work task type, wherein work personnel of a same group are bound with the same work task type, and work personnel of different groups are bound with different work task types; and

a first target personnel determining unit, operative to, after work tasks are generated, determine target work personnel responsible for corresponding work area(s) within a corresponding store and having a binding relationship with the types of the work tasks, and operative to allocate the work tasks to the target work personnel.

Clause 12. A work task claiming apparatus, comprising:

an information submitting unit, operative to submit information of work personnel within a store to a server, causing the server to group information of multiple work personnel within a same store and responsible for a same work area based on differences between work task types, and perform binding between each work personnel group and respective work task type, wherein work personnel within a same group are bound with the same work task type, and work personnel of different groups are bound with different work task types, the work personnel information including information of stores to which they belong and work areas which they are responsible for; and

a task receiving unit, operative to receive work tasks allocated by the server, wherein the work tasks are allocated based on the types of the tasks and binding relationships between the work personnel and the work task types.

Clause 13. A work task allocation apparatus, comprising:

a second personnel information determining unit, operative to determine information of work personnel within a store, the work personnel information including information of the work areas they are responsible for;

a second task type binding unit, operative to group information of multiple work personnel responsible for a same work area based on differences between work task types, and bind each group of work personnel with respective work task types, wherein work personnel within a same group are bound with the same work task type, and work personnel of different groups are bound with different work task types; and

a second target personnel determining unit, operative to, after work tasks are generated, determine target work personnel responsible for corresponding work area(s) and having a binding relationship with the types of the work tasks, and allocating the work tasks to the target work personnel on a prioritized basis.

Clause 14. A computing system, comprising:

one or more processors; and

memory related to the one or more processors, the memory operative to store program instructions, the program instructions upon being read and executed by the one or more processors, execute the following operations:
determine information of work personnel within multiple stores, the work personnel information including information of the stores to which they belong and the work areas they are responsible for;
group information of multiple work personnel within a same store and responsible for a same work area based on differences between work task types, and bind each group of work personnel with respective work task types, wherein work personnel within a same group are bound with the same work task type, and work personnel of different groups are bound with different work task types; and
determine, after work tasks are generated, target work personnel corresponding to target work area(s) within a target store and having a binding relationship to the types of the work tasks, and operative for the allocation of the target work personnel to the work tasks.

What is claimed is:

1. A method comprising:
determining information of work personnel within multiple stores, the work personnel information including information of stores they belong to and work areas they are responsible for;
grouping information of multiple work personnel responsible for a same work area within a same store based on differences in work task types, and binding each group of work personnel with respective work task types, wherein work personnel within a same group are bound with the same work task type, and work personnel of different groups are bound with different work task types; and
determining, after work tasks are generated, target work personnel responsible for the corresponding target work area(s) in a corresponding store and having a binding relationship to the types of work tasks, and allocating the work tasks to the target work personnel on a prioritized basis.

2. The method of claim 1, wherein grouping information of multiple work personnel responsible for a same work area within a same store based on differences in work task types comprises:
grouping work personnel information based on the number of work personnel within a same store and responsible for a same work area and the number of work task types.

3. The method of claim 2, wherein grouping work personnel information based on the number of work personnel within a same store and responsible for a same work area and the number of work task types comprises:
if the number of work personnel and the number of work task types are equal, forming each work personnel of the same store and responsible for the same work area as one group.

4. The method of claim 2, wherein grouping work personnel information based on the number of work personnel within a same store and responsible for a same work area and the number of work task types comprises:
if the number of work personnel is greater than the number of work task types, grouping work personnel ratio based on a preset allocation ratio.

5. The method of claim 4, further comprising:
counting, after binding each group of work personnel with respective work task types, actual generation incidences for each type of work task, and adjusting, based on the counting results, binding relationships between work personnel and work task types.

6. The method of claim 1, wherein binding each group of work personnel with respective work task types comprises:
based on historical binding information of each work personnel, determining the particular work task types that work personnel are bound with.

7. The method of claim 1, wherein at least one first work area is included within a same store, the first work area is utilized to store specific data objects, and the likelihood that data objects related to a same transactional order are specific data objects located at a same first work area exceeds a threshold; and
grouping information of multiple work personnel responsible for a same work area within a same store based on differences in work task types, and binding each group of work personnel with respective work task types, comprises:
grouping information of the multiple work personnel within the store and responsible for the first work area based on differences between work task types, and binding each group of work personnel with respective work task types.

8. The method of claim 7, further comprising:
merging orders based on transactional order information corresponding to a same store, and generating waves; wherein at the time of order merging, transactional orders whose related data objects are the specific data objects are merged as a first type of wave, and transactional orders whose related data objects include some of the specific data objects or which do not include the specific data objects are merged as a second type of wave; and
generating work tasks based on the type of the wave and the related data objects, wherein the work task type and the type of the wave correspond to each other.

9. The method of claim 7, further comprising:
if, within a particular work area, binding between work personnel and work task types has not taken place, allocating work task types randomly to the work personnel in the particular work area.

10. The method of claim 7, further comprising:
if, within a particular work area, binding between work personnel and work task types has not taken place, allocating work task types to the work personnel in the particular work area based on the amount of respective work tasks of each type.

11. An apparatus comprising:
one or more processors;
memory;
a first personnel information determining unit stored in the memory and executable by the one or more processors to cause the one or more processors to determine information of work personnel within multiple stores, the work personnel information including information of stores to which they belong and work areas to which they are responsible for;
a first task type binding unit stored in the memory and executable by the one or more processors to cause the one or more processors to group information of multiple work personnel within a same store and responsible for a same work area based on differences in work task types, and to bind each group of work personnel with a respective work task type, wherein work personnel of a same group are bound with the same work task type, and work personnel of different groups are bound with different work task types; and
a first target personnel determining unit stored in the memory and executable by the one or more processors to cause the one or more processors to determine, after work tasks are generated, target work personnel responsible for corresponding work area(s) within a corresponding store and having a binding relationship with the types of the work tasks, and to allocate the work tasks to the target work personnel.

12. The apparatus of claim 11, wherein the first task binding unit further comprises:
a grouping unit stored in the memory and executable by the one or more processors to cause the one or more processors to group work personnel information based on the number of work personnel within a same store and responsible for a same work area and the number of work task types.

13. The apparatus of claim 12, the grouping unit being further executable by the one or more processors to cause the one or more processors to:
if the number of work personnel and the number of work task types are equal, form each work personnel within a same store and responsible for the work area as one group.

14. The apparatus of claim 12, the grouping unit being further executable by the one or more processors to cause the one or more processors to:
if the number of work personnel is greater than the number of work task types, grouping work personnel information based on a preset allocation ratio.

15. The apparatus of claim 14, further comprising:
an adjusting unit stored in the memory and executable by the one or more processors to cause the one or more processors to count, after each group of work personnel and respective work task types has undergone binding, the actual generation situation of each type of work task, and adjust binding relationships between work personnel and work task types based on counting results.

16. The apparatus of claim 11, the first task type binding unit further being executable by the one or more processors to cause the one or more processors to:
determine, based on historical binding information of each work personnel, particular work task types bound to work personnel.

17. The apparatus of claim 11, the first task type binding unit further being executable by the one or more processors to cause the one or more processors to:
group information of the multiple work personnel within the store and responsible for the first work area based on differences between work task types, and perform binding between each group of work personnel and a respective work task type.

18. The apparatus of claim 17, further comprising:
a wave generating unit stored in the memory and executable by the one or more processors to cause the one or more processors to perform order merging based on transactional order information corresponding to a same store, and generate waves, wherein at the time of order merging, transactional orders whose related data objects are the specific data objects are merged as a first type of wave, and transactional orders whose related data objects include some of the specific data objects or which do not include the specific data objects are merged as a second type of wave; and
a work task generation unit stored in the memory and executable by the one or more processors to cause the one or more processors to generate work tasks based on the type of the wave and the related data objects, wherein, the work task type and the type of the wave correspond.

19. The apparatus of claim 17, the first task type binding unit further being executable by the one or more processors to cause the one or more processors to:
if within a particular work area corresponding to a particular work task, binding between work personnel and work task types has not taken place, randomly allocate work task types to the work personnel in the particular work area.

20. A computing system, comprising:
one or more processors; and
memory related to the one or more processors, the memory operative to store program instructions, the program instructions upon being read and executed by the one or more processors, execute the following operations:
determine information of work personnel within multiple stores, the work personnel information including information of the stores to which they belong and the work areas they are responsible for;
group information of multiple work personnel within a same store and responsible for a same work area based on differences between work task types, and bind each group of work personnel with respective work task types, wherein work personnel within a same group are bound with the same work task type, and work personnel of different groups are bound with different work task types; and
determine, after work tasks are generated, target work personnel corresponding to target work area(s) within a target store and having a binding relationship to the types of the work tasks, and operative for the allocation of the target work personnel to the work tasks.
